(19) United States
(12) Patent Application Publication
(10) Pub. No.: US 2022/0260999 A1
(43) Pub. Date: Aug. 18, 2022

(54) OBSTACLE DETECTION DEVICE

(71) Applicant: KABUSHIKI KAISHA TOYOTA JIDOSHOKKI, Kariya-shi (JP)

(72) Inventor: Shingo HATTORI, Aichi-ken (JP)

(73) Assignee: KABUSHIKI KAISHA TOYOTA JIDOSHOKKI, Kariya-shi (JP)

(21) Appl. No.: 17/669,763

(22) Filed: Feb. 11, 2022

(30) Foreign Application Priority Data
Feb. 17, 2021 (JP) 2021-023220

(51) Int. Cl. G05D 1/02; B66F 17/00

(52) U.S. Cl. CPC G05D 1/0214; G05D 2201/0216; G05D 1/024; B66F 17/003

(57) ABSTRACT

An obstacle detection device includes: a position and posture detector; a detection-disallowed-area setter; a detection-allowed-area determiner; and an obstacle detector. The position and posture detector detects a position and a posture of an object. The detection-disallowed-area setter sets an obstacle-detection disallowed area in which the object is undetectable as an obstacle based on the position and the posture of the object detected by the position and posture detector. The detection-allowed-area determiner determines an obstacle-detection allowed area in which the object is detectable as the obstacle based on the obstacle-detection disallowed area set by the detection-disallowed-area setter. The obstacle detector detects the obstacle in the obstacle-detection allowed area determined by the detection-allowed-area determiner. The detection-disallowed-area setter sets an area that encloses the object as the obstacle-detection disallowed area.

### CROSS-REFERENCE TO RELATED APPLICATION

This application claims priority to Japanese Patent Application No. 2021-023220 filed on Feb. 17, 2021, the entire disclosure of which is incorporated herein by reference.

The present disclosure relates to an obstacle detection device.

### BACKGROUND ART

Japanese Patent Application Publication No. 2020-140594 mentions an unmanned operation system that includes an environment map storage section, a temporary obstacle extracting section, and an environment map updating section, for example. The environment map storage section is configured to store an environment map on which obstacles that hinder the travelling of an industrial vehicle are shown. The temporary obstacle extracting section is configured to extract a temporary obstacle, which may be moved or removed with time, from the obstacles. The environment map updating section is configured to update the environment map stored in the environment map storage section based on the data on the temporary obstacle.

For a loading operation, however, the industrial vehicle, such as a forklift truck, may approach an object, such as a pallet or a truck, which is not on the map. In this situation, it may be inconvenient to the loading operation if the pallet or the truck is detected as an obstacle.

The present disclosure, which has been made in light of the above described problem, is directed to providing an obstacle detection device that is unlikely to falsely detect an object as an obstacle when an industrial vehicle approaches the object.

### SUMMARY

In accordance with an aspect of the present disclosure, there is provided an obstacle detection device for detecting an obstacle in a vicinity of an industrial vehicle when the industrial vehicle approaches an object. The obstacle detection device includes a position and posture detector; a detection-disallowed-area setter; a detection-allowed-area determiner; and an obstacle detection device. The position and posture detector is configured to detect a position and a posture of the object. The detection-disallowed-area setter is configured to set an obstacle-detection disallowed area in which the object is undetectable as the obstacle based on the position and the posture of the object detected by the position and posture detector. The detection-allowed-area determiner is configured to determine an obstacle-detection allowed area in which the object is detectable as the obstacle based on the obstacle-detection disallowed area set by the detection-disallowed-area setter. The obstacle detector is configured to detect the obstacle in the obstacle-detection allowed area determined by the detection-allowed-area determiner. The detection-disallowed-area setter is configured to set an area that encloses the object as the obstacle-detection disallowed area.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The present disclosure together with objects and advantages thereof, may best be understood by reference to the following description of the embodiments together with the accompanying drawings in which:

FIG. 1 is a schematic diagram of a travelling controller provided with an obstacle detection device according to an embodiment of the present disclosure;

FIGS. 2A-2C are conceptual diagrams of a forklift truck that is approaching a pallet;

FIG. 3 is a flowchart of a travelling control process that includes an obstacle detection process performed by a controller shown in FIG. 1;

FIGS. 4A-4B are conceptual diagrams of an obstacle-detection disallowed area and an obstacle-detection allowed area that are set when the forklift truck approaches a pallet; and

FIGS. 5A-5B are conceptual diagrams of an obstacle-detection disallowed area and an obstacle-detection allowed area that are set when the forklift truck approaches a container on a truck.

### DETAILED DESCRIPTION OF THE EMBODIMENTS

The following will describe an embodiment of the present disclosure in detail with reference to the accompanying drawings.

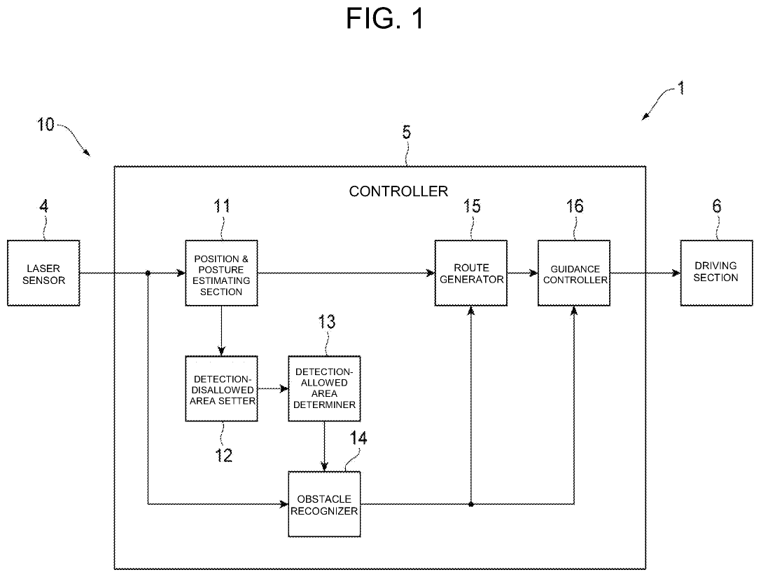

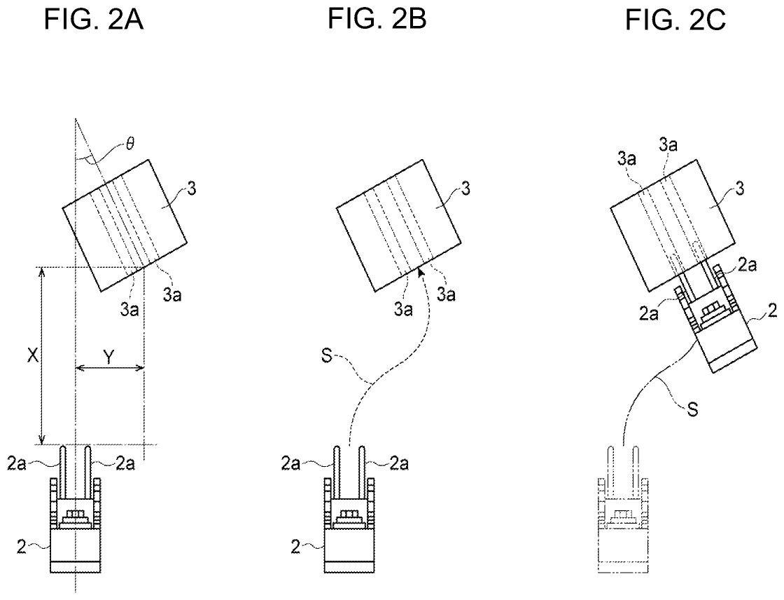

FIG. 1 is a schematic diagram of a travelling controller provided with an obstacle detection device according to an embodiment of the present disclosure. In FIG. 1, a travelling controller 1 is mounted to an autonomous forklift truck 2 (see FIGS. 2A-2C) that serves as an industrial vehicle.

The travelling controller 1 is configured to control the forklift truck 2 for the loading operation so that the forklift truck 2 autonomously travels just before a loaded pallet 3, as illustrated in FIGS. 2A-2C. The pallet 3 is a flat pallet, for example. The pallet 3 has a pair of fork holes 3a into which a pair of forks 2a of the forklift truck 2 is inserted. The pallet 3 is a loading object (i.e., the object of the present disclosure) that is loaded or unloaded by the forklift truck 2.

The travelling controller 1 is configured to control the forklift truck 2 so that the forklift truck 2 autonomously travels to a target position at which the forklift truck 2 can insert the forks 2a into the fork holes 3a of the pallet 3 so as to lift the pallet 3. The travelling controller 1 includes a laser sensor 4, a controller 5, and a driving section 6.

The laser sensor 4 detects an object that exists in the vicinity of the forklift truck 2 by irradiating the vicinity of the forklift truck 2 with a laser and receiving laser reflection. The object in the vicinity of the forklift truck 2 includes a stationary object, such as a wall or a post that is registered in the map, and a movable object, such as a vehicle, a load, or a container that is not registered in the map, for example. The laser sensor 4 may be a 2D or 3D laser rangefinder, for example.

The controller 5 includes a central processing unit (CPU), a random access memory (RAM), a read-only memory (ROM), and input/output interfaces. The controller 5 includes a position and posture estimating section 11, a detection-disallowed-area setter 12, a detection-allowed-area determiner 13, an obstacle recognizer 14, a route generator 15, and a guidance controller 16.

The laser sensor 4 cooperates with the position and posture estimating section 11, the detection-disallowed-area setter 12, the detection-allowed-area determiner 13, and the obstacle recognizer 14 of the controller 5 to form the obstacle detection device 10 of the present embodiment.

The obstacle detection device 10 detects an obstacle in the vicinity of the forklift truck 2 when the forklift truck 2 approaches the pallet 3. The obstacle in the vicinity of the forklift truck 2 includes a vehicle, a load, and a container that are not registered in the map as described above. Such an obstacle is likely to be moved or removed.

The position and posture estimating section 11 is configured to estimate the position and the posture of the pallet 3 by recognizing the pallet 3 based on the detection data of the laser sensor 4. The position of the pallet 3 is expressed in 2D (X, Y) position coordinates of the pallet 3 relative to the reference position of the forklift truck 2 as illustrated in FIG. 2A. The posture of the pallet 3 is expressed in the orientation (angle) θ of the pallet 3 with respect to the reference posture of the forklift truck 2 as illustrated in FIG. 2A. The position and posture estimating section 11 cooperates with the laser sensor 4 to serve as a position and posture detector of the present disclosure, which is configured to detect the position and the posture of the pallet 3 (i.e., the object).

Based on the position and the posture of the pallet 3 detected by the position and posture estimating section 11, the detection-disallowed-area setter 12 sets an obstacle-detection disallowed area in which the pallet 3 is undetectable as an obstacle. The function of the detection-disallowed-area setter 12 will be described later.

Based on the obstacle-detection disallowed area set by the detection-disallowed-area setter 12, the detection-allowed-area determiner 13 determines an obstacle-detection allowed area in which the pallet 3 is detectable as an obstacle. The function of the detection-allowed-area determiner 13 will be described later.

Based on the detection data of the laser sensor 4, the obstacle recognizer 14 recognizes the obstacle in the obstacle-detection allowed area determined by the detection-allowed-area determiner 13. The obstacle recognizer 14 cooperates with the laser sensor 4 to serve as an obstacle detector of the present disclosure, which is configured to detect an obstacle in the obstacle-detection allowed area.

Based on the position and the posture of the pallet 3 detected by the position and posture estimating section 11, the route generator 15 generates a driving route of the forklift truck 2. As shown in FIG. 2B, for example, the route generator 15 generates a driving route S that allows the forklift truck 2 to travel to the target position smoothly. When the obstacle recognizer 14 detects that an obstacle exists before the pallet 3, the route generator 15 may generate the driving route S so that the forklift truck 2 avoids the obstacle.

As shown in FIG. 2C, the guidance controller 16 controls the driving section 6 so that the forklift truck 2 is guided toward the target position along the driving route S generated by the route generator 15. The driving section 6 includes a driving motor and a steering motor, for example. When the obstacle recognizer 14 detects that an obstacle exists on the driving route S, the guidance controller 16 may control the driving section 6 so that the forklift truck 2 stops urgently.

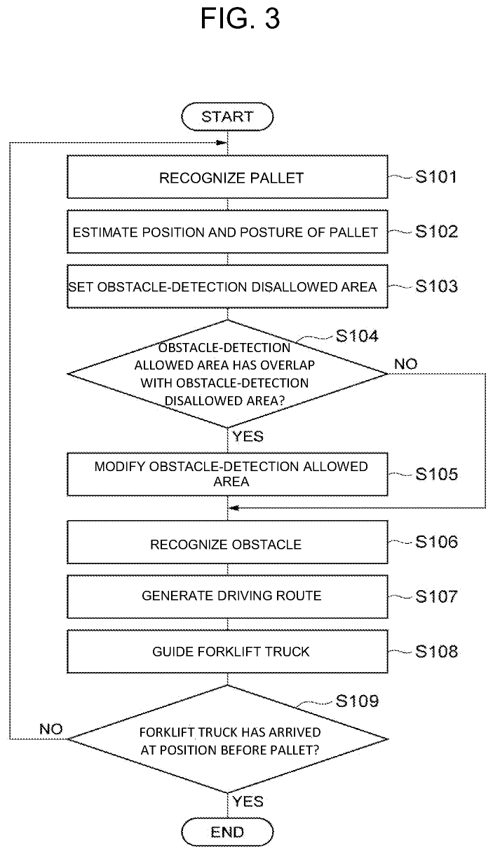

FIG. 3 is a flowchart of a travelling control process that includes an obstacle detection process performed by the controller 5. This process is performed, for example, when the distance between the forklift truck 2 and the pallet 3 is equal to or less than a specified distance in a state where the forklift truck 2 faces the pallet 3.

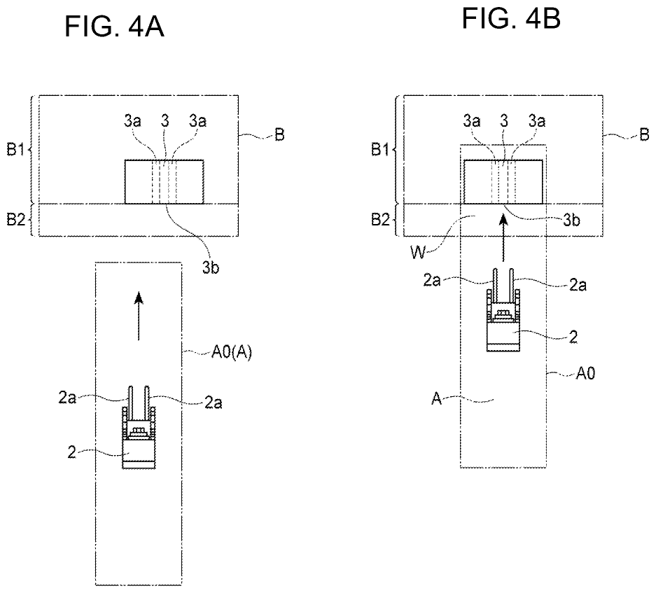

The obstacle-detection allowed area A in which the pallet 3 is detectable as an obstacle is determined preliminarily and initially as an initial obstacle-detection allowed area A0. The initial obstacle-detection allowed area A0 has a rectangular shape that encloses the whole of the forklift truck 2 as indicated by the chain double-dashed line in FIGS. 4A, 4B. In the initial obstacle-detection allowed area A0, the detection distance in the front-rear direction of the forklift truck 2 is longer than the detection distance in the right-left direction of the forklift truck 2.

As shown in FIG. 3, firstly, the controller 5 recognizes the pallet 3 based on the detection data of the laser sensor 4 (step S101). The controller 5 then estimates the position and the posture of the pallet 3 based on the detection data of the laser sensor 4 (step S102). The position and the posture of the pallet 3 are estimated with respect to the forklift truck 2 as described above (see FIG. 2A).

Next, based on the position and the posture of the pallet 3, the controller 5 (i.e., the detection-disallowed-area setter 12) sets an obstacle-detection disallowed area B in which the pallet 3 is undetectable as an obstacle (step S103). The obstacle-detection disallowed area B is an area that encloses the whole of the pallet 3 as shown in FIGS. 4A, 4B. Specifically, the pallet 3 has a front end face 3b that faces the forklift truck 2, and the obstacle-detection disallowed area B includes a main region B1 that spreads rearward from the front end face 3b of the pallet 3 in the front-rear direction of the pallet 3, and a margin B2 that spreads frontward from the front end face 3b of the pallet 3 in the front-rear direction of the pallet 3 (i.e., the margin B2 spreads from the front end face 3b on the forklift truck 2 side). The depth of the margin B2 is shorter than that of the main region B1. The depth is a distance in the front-rear direction of the pallet 3.

Next, the controller 5 determines whether the obstacle-detection allowed area A currently has an overlap with the obstacle-detection disallowed area B (step S104). When the controller 5 determines that the current obstacle-detection allowed area A has an overlap with the obstacle-detection disallowed area B (see FIG. 4B), the controller 5 modifies the obstacle-detection allowed area A so that the obstacle-detection allowed area A is not overlapped with the obstacle-detection disallowed area B (step S105). Specifically, the controller 5 removes an overlapping area W of the initial obstacle-detection allowed area A0, which is a part of the initial obstacle-detection allowed area A0 that is overlapped with the obstacle-detection disallowed area B. Accordingly, the obstacle-detection allowed area A (i.e., the latest obstacle-detection allowed area A) becomes narrower than the initial obstacle-detection allowed area A0.

When the controller 5 determines that the current obstacle-detection allowed area A does not have an overlap with the obstacle-detection disallowed area B (see FIG. 4A), the controller 5 does not execute step S105. That is, the controller 5 does not modify the obstacle-detection allowed area A. Accordingly, the initial obstacle-detection allowed area A0 is maintained as the latest obstacle-detection allowed area A.

Based on the detection data of the laser sensor 4, the controller 5 then recognizes an obstacle in the vicinity of the forklift truck 2 within the latest obstacle-detection allowed area A (step S106).

Further, based on the position and the posture of the pallet 3, the controller 5 generates the driving route S of the forklift truck 2 (see FIG. 2B) to the target position (step S107). The controller 5 controls the driving section 6 so that the forklift truck 2 is guided toward the target position along the driving route S (step S108).

Based on the detection data of the laser sensor 4, the controller 5 then determines whether the forklift truck 2 has arrived at the target position before the pallet 3 (step S109). When the controller 5 determines that the forklift truck 2 has not arrived at the target position, the controller 5 executes step S101 again. When the controller 5 determines that the forklift truck 2 has arrived at the target position, the controller 5 ends this process. Then, the forklift truck 2 automatically performs loading operation.

Note that, for sake of simplicity, this process does not include a step for generating a driving route S that avoids an obstacle or a step for bringing the forklift truck 2 to an emergency stop taken when an obstacle is detected.

Step S101 and step S102 are executed by the position and posture estimating section 11. Step S103 is executed by the detection-disallowed-area setter 12. Step S104 and step S105 are executed by the detection-allowed-area determiner 13. Step S106 is executed by the obstacle recognizer 14. Step S107 is executed by the route generator 15. Step S108 and step S109 are executed by the guidance controller 16.

In this travelling control device 1, when the forklift truck 2 is positioned away from the pallet 3, the predetermined initial obstacle-detection allowed area A0 does not have an overlap with the obstacle-detection disallowed area B that encloses the pallet 3, as shown in FIG. 4A. In this case, the initial obstacle-detection allowed area A0 is determined as the latest obstacle-detection allowed area A.

When the forklift truck 2 approaches the pallet 3, a part of the initial obstacle-detection allowed area A0 overlaps with the obstacle-detection disallowed area B in the overlapping area W, as shown in FIG. 4B. In this case, an area of the initial obstacle-detection allowed area A0 from which the overlapping area W is removed is determined as the latest obstacle-detection allowed area A. Accordingly, this latest obstacle-detection allowed area A is reduced by the overlapping area with the obstacle-detection disallowed area B.

The obstacle-detection allowed area A is further reduced as the forklift truck 2 further approaches the pallet 3 since the overlapping area W of the initial obstacle-detection allowed area A0, which is overlapped with the obstacle-detection disallowed area B, increases.

As described above, in this embodiment, first, the position and the posture of the pallet 3 are detected when the forklift truck 2 approaches the pallet 3. Then, based on the position and the posture of the pallet 3 detected, the obstacle-detection disallowed area B in which the pallet 3 is undetectable as an obstacle in the vicinity of the forklift truck 2 is set. Then, the obstacle-detection allowed area A in which the pallet 3 is detectable as an obstacle is determined based on the obstacle-detection disallowed area B, so that the detection of the obstacle is performed in the obstacle-detection allowed area A. In this situation, the area that encloses the pallet 3 is set as the obstacle-detection disallowed area B. This prevents the pallet 3 from being falsely detected as an obstacle. Therefore, the forks 2a of the forklift truck 2 lift the pallet 3 without fail.

Further, in this embodiment, the margin B2 that spreads frontward from the front end face 3b of the pallet 3 (i.e., on the forklift truck 2 side) is set by the detection-disallowed-area setter 12 as a part of the obstacle-detection disallowed area B. This appropriately provides the obstacle-detection disallowed area B even if a detection error may occur in the position and the posture of the pallet 3. This therefore further prevents the pallet 3 from being falsely detected as an obstacle.

Further, in this embodiment, when it is determined that the obstacle-detection allowed area A has an overlap with the obstacle-detection disallowed area B, the obstacle-detection allowed area A is modified so that the obstacle-detection allowed area A is not overlapped with the obstacle-detection disallowed area B. Accordingly, the obstacle-detection allowed area A does not overlap with the obstacle-detection disallowed area B when the forklift truck 2 thoroughly approaches the pallet 3. This therefore further prevents the pallet 3 from being falsely detected as an obstacle.

In this embodiment, when the obstacle-detection allowed area A has an overlap with the obstacle-detection disallowed area B, the overlapping area W of the obstacle-detection allowed area A, which is overlapped with the obstacle-detection disallowed area B, is removed. This provides the obstacle-detection allowed area A appropriately according to the distance between the forklift truck 2 and the pallet 3 even when the forklift truck 2 thoroughly approaches the pallet 3.

The present disclosure is not limited to the above-described embodiment. According to the embodiment, for example, an obstacle in the vicinity of the forklift truck 2 is detected when the forklift truck 2 approaches the pallet 3 to handle the pallet 3. However, the loading object is not limited to the pallet 3.

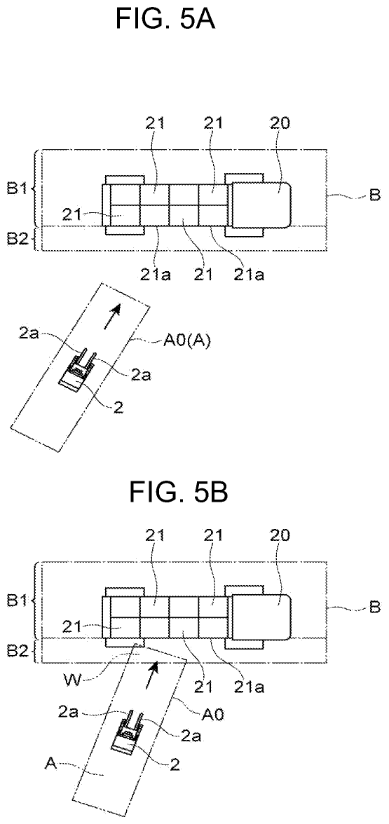

For example, as illustrated in FIGS. 5A-5B, the obstacle in the vicinity of the forklift truck 2 may be detected when the forklift truck 2 approaches containers 21 of a truck 20 to pick up loaded pallets from the containers 21. The containers 21 are also loading objects (i.e., the objects of the present disclosure) that are loaded or unloaded by the forklift truck 2. The containers 21 are placed on a loading platform of the truck 20 in a double line.

In this case, the obstacle-detection disallowed area B is an area that encloses the whole of the truck 20. Specifically, each container 21 in the front line has a front end face 21a that faces the forklift truck 2, and the obstacle-detection disallowed area B includes the main region B1 that spreads rearward from the front end face 21a of the container 21 in the front-rear direction of the container 21, and the margin B2 that spreads frontward from the front end face 21a of the container 21 (i.e., the margin B2 spreads from the front end face 21a on the forklift truck 2 side). The front end face 21a of the container 21 is an end face on a door side of the container 21.

When the forklift truck 2 is positioned away from the truck 20, as shown in FIG. 5A, the predetermined initial obstacle-detection allowed area A0 does not have an overlap with the obstacle-detection disallowed area B that encloses the truck 20. In this case, the initial obstacle-detection allowed area A0 is determined as the latest obstacle-detection allowed area A.

When the forklift truck 2 approaches the truck 20, a part of the initial obstacle-detection allowed area A0 overlaps with the obstacle-detection disallowed area B, as shown in FIG. 5B. Accordingly, the obstacle-detection allowed area A is narrower than the initial obstacle-detection allowed area A0 by a part of the obstacle-detection allowed area A0 that is overlapped with the obstacle-detection disallowed area B.

According to this embodiment, when the obstacle-detection allowed area A has an overlap with the obstacle-detection disallowed area B, the overlapping area W of the obstacle-detection allowed area A, which is overlapped with the obstacle-detection disallowed area B, is removed. However, the present disclosure is not limited thereto. The obstacle-detection allowed area A may be modified in another way as long as the obstacle-detection allowed area A is not overlapped with the obstacle-detection disallowed area B. For example, the obstacle-detection allowed area A may be further reduced by removing a part of the obstacle-detection allowed area A larger than the overlapping area W.

According to this embodiment, the obstacle-detection disallowed area B partially includes a region that spreads frontward from the front end face of the loading object, such as the pallet 3 or the container 21. However, the present disclosure is not limited thereto. For example, the obstacle-detection disallowed area B may consist of a region that spreads rearward from the front end face of the loading object if a detection error less occurs in the position and the posture of the loading target.

Further, according to this embodiment, the obstacle-detection disallowed area B is an area that encloses the whole of the loading object. However, the present disclosure is not limited thereto. For example, the region that spreads rearward from the front end face of the loading object may be removed from the obstacle-detection disallowed area B.

According to this embodiment, the position and the posture of the pallet 3 are estimated and the obstacle is recognized based on the detection data of the laser sensor 4. However, the present disclosure is not limited thereto. For example, the position and the posture of the pallet 3 may be estimated and the obstacle may be recognized based on an image captured by a camera, for example.

According to the embodiment, the obstacle in the vicinity of the forklift truck 2 is detected when the forklift truck 2 approaches the loading object. However, the present disclosure is not limited to the forklift truck 2. For example, the present disclosure is applicable to an industrial vehicle, such as a towing vehicle, which approaches an object to be loaded or unloaded by the industrial vehicle.

What is claimed is:

1. An obstacle detection device for detecting an obstacle in a vicinity of an industrial vehicle when the industrial vehicle approaches an object, the obstacle detection device comprising:
a position and posture detector configured to detect a position and a posture of the object;
a detection-disallowed-area setter configured to set an obstacle-detection disallowed area in which the object is undetectable as the obstacle based on the position and the posture of the object detected by the position and posture detector;
a detection-allowed-area determiner configured to determine an obstacle-detection allowed area in which the object is detectable as the obstacle based on the obstacle-detection disallowed area set by the detection-disallowed-area setter; and
an obstacle detector configured to detect the obstacle in the obstacle-detection allowed area determined by the detection-allowed-area determiner, wherein
the detection-disallowed-area setter is configured to set an area that encloses the object as the obstacle-detection disallowed area.

2. The obstacle detection device according to claim 1, wherein the detection-disallowed-area setter is configured to set a region that spreads from a front end face of the object on the industrial vehicle side as a part of the obstacle-detection disallowed area.

3. The obstacle detection device according to claim 1, wherein the detection-allowed-area determiner is configured to modify the obstacle-detection allowed area so that the obstacle-detection allowed area is not overlapped with the obstacle-detection disallowed area, when the obstacle-detection allowed area has an overlap with the obstacle-detection disallowed area.

4. The obstacle detection device according to claim 3, wherein the detection-allowed-area determiner is configured to remove an overlapping area of the detection-allowed area that is overlapped with the obstacle-detection disallowed area, when the obstacle-detection allowed area has the overlap with the obstacle-detection disallowed area.
